(19) United States
(12) Patent Application Publication
(10) Pub. No.: US 2023/0250220 A1
(43) Pub. Date: Aug. 10, 2023

(54) PROCESS FOR PREPARING A CROSSLINKED THERMOPLASTIC POLYURETHANE AND ARTICLES THEREOF

(71) Applicant: BASF SE, Ludwigshafen am Rhein (DE)

(72) Inventors: Sam KHARCHENKO, Wyandotte, MI (US); Mark D. Swartzlander, Wyandotte, MI (US); Mihai Manitiu, Wyandotte, MI (US)

(73) Assignee: BASF SE, Ludwigshafen am Rhein (DE)

(21) Appl. No.: 18/004,627

(22) PCT Filed: Jul. 9, 2021
(86) PCT No.: PCT/EP2021/069239

§ 371 Date: Jan. 6, 2023

Related U.S. Application Data
(60) Provisional application No. 63/050,136, filed on Jul. 10, 2020.

(30) Foreign Application Priority Data
Oct. 6, 2020 (EP) 20200414.9

(51) Int. Cl. C08G 18/79; C08G 18/76; C08G 18/42; C08G 18/08

(52) U.S. Cl. CPC C08G 18/797; C08G 18/7671; C08G 18/4241; C08G 18/0895; C08G 2410/00

(57) ABSTRACT

A process can be used for preparing a crosslinked thermoplastic polyurethane (TPU), which is useful for producing injection molded products, extrusion products, films, and shaped bodies. Particularly, the crosslinked TPUs are useful for making outsole of footwear.

### FIELD OF INVENTION

The present invention relates to a process for preparing a crosslinked thermoplastic polyurethane (TPU) and its use for producing injection molded products, extrusion products, films and shaped bodies. Particularly, use of the crosslinked TPUs for making outsole of footwear is disclosed.

### BACKGROUND OF THE INVENTION

The production of thermoplastic polyurethanes, hereinafter referred to as TPUs for short, is generally known. TPUs are partly crystalline materials and belong to the class of thermoplastic elastomers. A characteristic of polyurethane elastomers is the segmented structure of the macro molecules. Owing to the differing cohesion energy densities of these segments, a phase separation into crystalline “hard” and amorphous “soft” regions occurs in the ideal case. The resulting two-phase structure determines the property profile of TPUs. Thermoplastic polyurethanes are plastics having a wide range of applications. Thus, TPUs are used, for example, in the automobile industry, e.g. in dashboard skins, in films, in cable sheathing, in the leisure industry, as deposition areas, as functional and design elements in sports shoes, as flexible component in rigid-flexible combinations and in many further applications.

It is known from the literature that the property profile of TPU can be improved by introducing crosslinking into the TPU, leading to the strength being increased, the tensile and compressive sets being reduced, the resistance to the media of all types, resilience and creep behaviour being improved.

Known crosslinking methods are, inter alia, UV or electron beam crosslinking, crosslinking via siloxane groups and the formation of crosslinks by addition of isocyanates to the molten TPU. The reaction of a TPU, preferably in the molten state, with compounds bearing isocyanate groups is also referred to as prepolymer crosslinking and is generally known from U.S. Pat. No. 8,318,868 B2, US 2008/0207846 A1, DE-A 41 15 508, DE-A 4 412 329, and EP-A 922 719. Despite this general knowledge of the possible ways of achieving prepolymer crosslinking, requirement of a complicated apparatus for conducting these processes rendered them not being implemented in industrial practice. The reaction of the TPU with the compounds having isocyanate groups also represents a difficult task, since mixing of the molten TPU with diisocyanates can lead to a degradation of the molecular weight of the TPUs, while mixing with triisocyanates and polyisocyanates can cause an increase in the molecular weight as far as crosslinking of the TPUs in extruder and result in thermosets.

Further, if a desired range of TPU hardness is set and is constrained, but a certain level of performance is required at elevated temperatures, for e.g. 100° C. to 160° C., the conventional selection of the diol chemistries and the di-functional isocyanates may be limited.

Additionally, a crosslinked TPU material with acceptable thermal and mechanical properties, such as but not limited to, abrasion resistance, extended elastic performance, glass transition temperature, with processing being done on a conventional system and yet with improved cycle time is difficult to obtain.

It was, therefore, an object of the present invention to provide a cross-linked TPU having extended elastic performance, acceptable mechanical properties, such as but not limited to, abrasion resistance, tensile strength, and is processable on conventional systems with improved cycle time, thereby rendering it useful for producing injection molded products, extrusion products, films and shaped bodies, in particular outsoles for footwear.

### SUMMARY OF THE INVENTION

Surprisingly, it has been found that the above-identified object is met by providing a process for preparing a crosslinked TPU, wherein a carbodiimide-modified isocyanate having an isocyanate functionality ranging between 2.1 to 2.7, is reacted with a polyol composition comprising at least one polyol having a nominal functionality ranging between 1.8 to 2.5 and OH value ranging between 20 mg KOH/g to 500 mg KOH/g, and chain extender.

Accordingly, in one aspect, the presently claimed invention is directed to a process for preparing a crosslinked thermoplastic polyurethane, said process comprising at least reacting a mixture comprising:
(a) an isocyanate composition comprising a first isocyanate which is a carbodiimide-modified isocyanate having an isocyanate functionality ranging between 2.1 to 2.7,
(b) a polyol composition comprising at least one polyol having a nominal functionality ranging between 1.8 to 2.5 and OH value ranging between 20 mg KOH/g to 500 mg KOH/g, and
(c) at least one chain extender.

In another aspect, the presently claimed invention is directed to the above crosslinked TPU.

In another aspect, the presently claimed invention is directed to the use of the above crosslinked TPU for production of injection molded products, extrusion products, films and shaped bodies.

In yet another aspect, the presently claimed invention is directed to an outsole for an article of footwear comprising the above crosslinked thermoplastic polyurethane.

In a further aspect, the presently claimed invention is directed to an article of footwear comprising an upper, a midsole and the above outsole.

### DETAILED DESCRIPTION OF THE INVENTION

Before the present compositions and formulations of the invention are described, it is to be understood that this invention is not limited to particular compositions and formulations described, since such compositions and formulation may, of course, vary. It is also to be understood that the terminology used herein is not intended to be limiting, since the scope of the present invention will be limited only by the appended claims.

The terms “comprising”, “comprises” and “comprised of” as used herein are synonymous with “including”, “includes” or “containing”, “contains”, and are inclusive or open-ended and do not exclude additional, non-recited members, elements or method steps. It will be appreciated that the terms “comprising”, “comprises” and “comprised of” as used herein comprise the terms “consisting of”, “consists” and “consists of”.

Furthermore, the terms “first”, “second”, “third” or “(a)”, “(b)”, “(c)”, “(d)” etc. and the like in the description and in the claims, are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein. In case the terms “first”, “second”, “third” or “(A)”, “(B)” and “(C)” or “(a)”, “(b)”, “(c)”, “(d)”, “i”, “ii” etc. relate to steps of a method or use or assay there is no time or time interval coherence between the steps, that is, the steps may be carried out simultaneously or there may be time intervals of seconds, minutes, hours, days, weeks, months or even years between such steps, unless otherwise indicated in the application as set forth herein above or below.

In the following passages, different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Reference throughout this specification to “one embodiment” or “an embodiment” means that a particular feature, structure or characteristic described in connection with the embodiment is included in at least one embodiment of the present invention. Thus, appearances of the phrases “in one embodiment” or “in an embodiment” in various places throughout this specification are not necessarily all referring to the same embodiment but may. Furthermore, the features, structures or characteristics may be combined in any suitable manner, as would be apparent to a person skilled in the art from this disclosure, in one or more embodiments. Furthermore, while some embodiments described herein include some, but not other features included in other embodiments, combinations of features of different embodiments are meant to be within the scope of the invention, and form different embodiments, as would be understood by those in the art. For example, in the appended claims, any of the claimed embodiments can be used in any combination.

Furthermore, the ranges defined throughout the specification include the end values as well, i.e. a range of 1 to 10 implies that both 1 and 10 are included in the range. For the avoidance of doubt, the applicant shall be entitled to any equivalents according to applicable law.

An aspect of the present invention is embodiment 1, directed towards a process for preparing a crosslinked thermoplastic polyurethane, said process comprising at least reacting a mixture comprising:
(a) an isocyanate composition comprising a first isocyanate which is a carbodiimide-modified isocyanate having an isocyanate functionality ranging between 2.1 to 2.7,
(b) a polyol composition comprising at least one polyol having a nominal functionality ranging between 1.8 to 2.5 and OH value ranging between 20 mg KOH/g to 500 mg KOH/g, and
(c) at least one chain extender.

In the present context, OH value is determined according to DIN 53240-1. Further, isocyanate reactive component (IRC) in the present context refers to the polyol composition and the chain extenders together.

Unlike the existing crosslinked TPUs, the isocyanates are added during the TPU formation stage. Said otherwise, the present invention TPU differs over the state of the art in the sense that no isocyanate is added post formation of the TPU, for e.g. during extrusion, and that the regular isocyanates added in the state of the art TPUs is replaced by isocyanates having functionality of greater than 2.0. The present invention focuses on selecting suitable isocyanates in calculated amounts, which result in the resulting TPU having improved thermal properties, such as extended elastic plateau, and acceptable mechanical properties, and is still processable in conventional systems with increased cycle times.

### Isocyanate Composition

In one embodiment, the isocyanate composition in the embodiment 1 comprises a first isocyanate which is a carbodiimide-modified isocyanate having an isocyanate functionality ranging between 2.1 to 2.7. In another embodiment, the isocyanate functionality of the first isocyanate in the embodiment 1 ranges between 2.1 to 2.6, or 2.1 to 2.5, or 2.1 to 2.4. In yet another embodiment, the isocyanate functionality of the first isocyanate in the embodiment 1 ranges between 2.1 to 2.3, or 2.1 to 2.2.

The isocyanate content of the first isocyanate in the embodiment 1 is less than 50 wt.-%. In an embodiment, the isocyanate component of the first isocyanate in the embodiment 1 is in between 1 wt.-% to 40 wt.-%, or 1 wt.-% to 35 wt.-%, or 5 wt.-% to 35 wt.-%, or 10 wt.-% to 35 wt.-%. In another embodiment, the isocyanate component of the first isocyanate in the embodiment 1 is in between 15 wt.-% to 35 wt.-%, or 20 wt.-% to 35 wt.-%, or 25 wt.-% to 35 wt.-%.

In one embodiment, the first isocyanate in the embodiment 1 is selected from a carbodiimide-modified diphenylmethane 2,2′-, 2,4′- and/or 4,4′-diisocyanate. In another embodiment, the first isocyanate in the embodiment 1 is a carbodiimide-modified diphenylmethane 4,4′-diisocyanate (4,4′-MDI) having an isocyanate content in between 27 wt. % to 32 wt. %.

In another embodiment, the isocyanate composition in the embodiment 1 further comprises a second isocyanate having an isocyanate functionality of at least 2.0, said second isocyanate being different than the first isocyanate. Suitable second isocyanates have an isocyanate content of at least 5.0 wt.-%. In another embodiment, the second isocyanate in the isocyanate composition in the embodiment 1 have an isocyanate content in between 5 wt. % to 50 wt. %, or in between 20 wt. % to 50 wt. %, or in between 30 wt. % to 50 wt. %, the said second isocyanates being different than the first isocyanate.

Suitable second isocyanates in the isocyanate composition in the embodiment 1 are selected from a prepolymer based on diphenylmethane 2,2′-, 2,4′- and/or 4,4′-diisocyanate, isocyanates comprising biuret and/or isocyanurate groups, diphenylmethane 2,2′-, 2,4′- and/or 4,4′-diisocyanate, and polymeric methylene diphenyl diisocyanate.

Suitable H-functional compounds used in the prepolymer are known to a person skilled in the art. In one embodiment, the H-functional compounds for the prepolymers include polyfunctional alcohols, for e.g. polyethers. In another embodiment, the prepolymer is based on diphenylmethane 2,2′-, 2,4′- and/or 4,4′-diisocyanate, alkane diols, for e.g. dipropylene glycol, having a molecular weight in between 60 g/mol to 400 g/mol, and polyether diol, for e.g. polypropylene glycol, having a molecular weight (Mw) in between 500 g/mol to 4000 g/mol.

Isocyanates comprising biuret and/or isocyanurate groups as suitable second isocyanate in the isocyanate composition in the embodiment 1 have an isocyanate content in between 20 wt. % to 25 wt. % and a viscosity at 23° C. in between 2500 mPas to 4000 mPas determined according to DIN EN ISO 3219.

Diphenylmethane 2,2′-, 2,4′- and/or 4,4′-diisocyanate are different isomeric forms of diphenylmethane diisocyanate (MDI). MDI can be classified into monomeric methylene MDI and polymeric MDI. Polymeric MDI includes oligomeric species and MDI isomers. Thus, polymeric MDI may contain a single MID isomer or isomer mixtures thereof, with the balance being oligomeric species. Polymeric MDI tends to have isocyanate functionalities of higher than 2.0. The isomeric ratio as well as the amount of oligomeric species can vary in wide ranges in these products. For instance, polymeric MDI may typically contain 30 wt.-% to 80 wt.-% of MDI isomers, the balance being said oligomeric species. The MDI isomers are often a mixture of 4,4′-MDI, 2,4′-MDI and very low levels of 2,2′-MDI. In one embodiment, the second isocyanate in the isocyanate composition in the embodiment 1 is 4,4′-MDI having isocyanate content in between 30 wt. % to 35 wt. %.

In one embodiment, the isocyanate composition in the embodiment 1 comprises a mixture of first isocyanate and second isocyanate. The weight ratio between the first isocyanate and the second isocyanate in the isocyanate composition in the embodiment 1 is in between 1.0:100.0 to 100.0:1.0. In an embodiment, the weight ratio between the first isocyanate and the second isocyanate in the isocyanate composition in the embodiment 1 is in between 1.0:20.0 to 20.0:1.0, or 1.0:15.0 to 15.0:1.0, or 1.0:10.0 to 10.0:1.0. In another embodiment, the weight ratio between the first isocyanate and the second isocyanate in the isocyanate composition in the embodiment 1 is in between 1.0:5.0 to 5.0:1.0, or 1.0:5.0 to 4.0:1.0, or 1.0:5.0 to 3.0:1.0, or 1.0:5.0 to 2.0:1.0, or 1.0:5.0 to 1.0:1.0.

In an embodiment, the isocyanate composition in the embodiment 1 may also comprise one or more solvents. Suitable solvents are known to those skilled in the art. Suitable examples are nonreactive solvents such as ethyl acetate, methyl ethyl ketone and hydrocarbons.

Polyol composition

In an embodiment, the polyol composition in the embodiment 1 comprises at least one polyol having a nominal functionality ranging between 1.8 to 2.5 and OH value ranging between 20 mg KOH/g to 500 mg KOH/g.

In one embodiment, the polyol in the embodiment 1 has a nominal functionality ranging between 1.8 to 2.4, or in between 1.8 to 2.3, or in between 1.8 to 2.2, or in between 1.9 to 2.2, or in between 1.9 to 2.1. In another embodiment, the polyol in the embodiment 1 has OH value ranging between 20 mg KOH/g to 450 mg KOH/g, or in between 20 mg KOH/g to 350 mg KOH/g, or in between 20 mg KOH/g to 300 mg KOH/g. In yet another embodiment, the polyol in the embodiment 1 has OH value ranging between 20 mg KOH/g to 250 mg KOH/g, or in between 30 mg KOH/g to 250 mg KOH/g, or in between 30 mg KOH/g to 200 mg KOH/g. In still another embodiment, the polyol in the embodiment 1 has OH value ranging between 30 mg KOH/g to 150 mg KOH/g, or in between 30 mg KOH/g to 100 mg KOH/g, or in between 40 mg KOH/g to 70 mg KOH/g, or in between 50 mg KOH/g to 60 mg KOH/g.

Suitable polyols in the polyol composition in the embodiment 1 can be selected from polyether polyols, polyester polyols, and polycarbonate polyols. In one embodiment, the polyol in the embodiment 1 comprises a polyether polyol or a polyester polyol having a nominal functionality ranging between 1.9 to 2.1 and OH value ranging between 40 mg KOH/g to 70 mg KOH/g.

Polyether polyols are obtained by known methods, such as but not limited to, reaction between at least one starter molecule, such as ethylene glycol, propylene glycol, glycerine, pentaerythritol, trimethylpropane, sucrose, or sorbitol, and alkylene oxide such as ethylene oxide (EO), propylene oxide (PO), mixtures of EO and PO or tetrahydrofuran.

In an embodiment, the polyether polyols in the polyol in the embodiment 1 include polytetramethylene ether glycol (also referred as PTMEG), polypropylene oxide glycol, and polybutylene oxide glycol. In another embodiment, PTMEG or a-hydro-w- hydroxypoly(oxytetra-methylene) diol may be used as suitable polyol in the embodiment 1. Such polyether polyols may have a number average molecular average weight Mn between 500 g/mol to 3.0×10³ g/mol.

Suitable polyester polyols as polyol in the embodiment 1 can be selected from the reaction products of polyhydric alcohol, polymerization product of lactone and polymerization product of di-carboxylic acids with polyhydric alcohols. By the term “lactone”, it is referred to cyclic esters of hydrocarboxylic acids. Such polyester polyols include hydroxyl-terminated reaction products of polyhydric alcohols, polyester polyols obtained as the polymerization product of lactone, e.g. caprolactone, in conjunction with a polyol, and polyester polyols obtained by the polymerization of a dicarboxylic acid, e.g. adipic acid, with polyhydric alcohol.

In an embodiment, the polyester polyol as the polyol in the embodiment 1 is obtained by the reaction product of dicarboxylic acid with polyhydric alcohol. Suitable dicarboxylic acid is at least one of C₄ to C₁₂ dicarboxylic acid, while at least one of C₂ to C₁₄ diol are suitable as polyhydric alcohol. In one embodiment, the C₄ to C₁₂ dicarboxylic acid is selected from aliphatic dicarboxylic acid such as succinic acid, glutaric acid, adipic acid, suberic acid, azelaic acid, and sebacic acid and aromatic dicarboxylic acid such as phthalic acid, isophthalic acid, and terephthalic acid. In another embodiment, the C₄ to C₁₂ dicarboxylic acid is selected from adipic acid, suberic acid, phthalic acid, and terephthalic acid. In yet another embodiment, the C₄ to C₁₂ dicarboxylic acid is selected from adipic acid, and terephthalic acid. In still another embodiment, the C₄ to C₁₂ dicarboxylic acid is adipic acid.

In one embodiment, the C₂ to C₁₄ diol is selected from ethylene glycol, diethylene glycol, 1,4-butanediol, 1,5-pentanediol, 1,6-hexanediol, 1,10-decanediol, 2,2-dimethyl-propane-1,3-diol, 1,3-propanediol, 2-methyl-1,3-propanediol and dipropylene glycol. Mixture of these diols can also be used. In another embodiment, the C₂ to C₁₄ diol is selected from ethylene glycol, diethylene glycol, 1,4-butanediol, 1,5-pentanediol, 1,6-hexanediol, and dipropylene glycol. In still another embodiment, the C₂ to C₁₄ diol is selected from ethylene glycol, 1,4-butanediol, and 1,6-hexanediol. In yet another embodiment, the C₂ to C₁₄ diol is ethylene glycol, and/or 1,4-butanediol.

In one embodiment, the polyester polyol in the polyol in the embodiment 1 is an adipic acid based polyester polyol having a nominal functionality ranging between 1.9 to 2.1 and OH value in between 50 mg KOH/g to 60 mg KOH/g.

In another embodiment, the polyester polyol in the polyol in the embodiment 1 is a reaction product of adipic acid with ethylene glycol, and 1,4-butanediol, having a nominal functionality ranging between 1.9 to 2.1 and OH value in between 50 mg KOH/g to 60 mg KOH/g.

Suitable polycarbonate polyols are obtained by, such as but not limited to, the reaction of phosgene or a carbonate monomer, usually dimethyl carbonate with a diol monomer or a mixture of diol monomers. Alternatively, suitable hydroxyl terminated polycarbonates include those prepared by reacting a glycol with a carbonate. U.S. Pat. No. 4,131,731 describes such hydroxyl terminated polycarbonates. The polycarbonates are linear and have terminal hydroxyl groups with essential exclusion of other terminal groups. The essential reactants are glycols and carbonates. Suitable glycols are selected from cycloaliphatic and aliphatic diols containing 4 to 40, or 4 to 12 carbon atoms, and from polyoxyalkylene glycols containing 2 to 20 alkoxy groups per molecule with each alkoxy group containing 2 to 4 carbon atoms. Examples of such diols include 1,4-butanediol, 1,5-pentanediol, neopentyl glycol, 1,6-hexanediol, 2,2,4- trimethylhexane-1,6-diol, 1,10-decanediol, hydrogenated dilinoleylglycol, hydrogenated dioleylglycol, 1,3-cyclohexanediol, 1,4-dimethylolcyclohexane, 1,4-cyclohexanediol, 1,3- dimethylolcyclohexane, 1,4-endo methylene-2-hydroxy-5-hydroxymethyl cyclohexane, and polyalkylene glycol. The diols used in the reaction may be a single diol or a mixture of diols depending on the properties desired in the finished product.

Suitable carbonates are selected from alkylene carbonates composed of a 5 to 7-member ring. Examples include ethylene carbonate, trimethyl carbonate, tetramethylene carbonate, 1,2-propylene carbonate, 1,2-butylene carbonate, 2,3-butylene carbonate, 1,2-ethylene carbonate, 1,3-pentylene carbonate, 2,3-pentylene carbonate, and 2,4-pentylene carbonate. Also, suitable herein are dialkylcarbonates, cycloaliphatic carbonates, and diarylcarbonates. The dialkylcarbonates can contain 2 to 5 carbon atoms in each alkyl group, and specific examples thereof are diethylcarbonate and dipropylcarbonate. Cycloaliphatic carbonates, especially dicycloaliphatic carbonates, can contain 4 to 7 carbon atoms in each cyclic structure and there can be one or two of such structures. When one group is cycloaliphatic, the other can be either alkyl or aryl. On the other hand, if one group is aryl, the other can alkyl or cycloaliphatic.

### Chain Extender

In an embodiment, the chain extender in the embodiment 1 has a molecular weight of less than 499 g/mol. In the context of the present invention, the chain extender is understood to mean a compound having at least two functional groups reactive toward isocyanates, for example hydroxyl groups, amino groups or thiol groups, and a molecular weight Mw of less than 499 g/mol. At the same time, in the context of the present invention, the polyol composition in the embodiment 1 is also free of compounds of this kind.

In one embodiment, the chain extenders in the embodiment 1 have a molecular weight less than 300 g/mol, or in between 50 g/mol to 210 g/mol. In another embodiment, the chain extender in the embodiment 1 has a molecular weight in between 50 g/mol to 150 g/mol, or in between 50 g/mol to 100 g/mol, or in between 60 g/mol to 100 g/mol.

Suitable chain extenders in the embodiment 1 can be selected from ethylene glycol, 1,2-propanediol, 1,3-propanediol, 1-5 pentanediol, 1,6-hexanediol, 1,10-decanediol, 1,2-dihydroxycyclohexane, 1,3-dihydroxycyclohexane, 1,4-dihydroxycyclohexane, diethylene glycol, 1,4-butanediol, bis(2-hydroxy-ethyl)hydroquinone, dipropylene glycol, glycerol, diethanolamine, and triethanolamine. In another embodiment, the chain extender in the embodiment 1 can be selected from ethylene glycol, 1,2-propanediol, 1,3-propanediol, 1-5 pentanediol, 1,6-hexanediol, 1,10-decanediol, 1,2-dihydroxycyclohexane, 1,3-dihydroxycyclohexane, 1,4-dihydroxycyclohexane, and diethylene glycol. In yet another embodiment, the chain extender in the embodiment 1 can be selected from ethylene glycol, 1,2-propanediol, 1,3-propanediol, 1-5 pentanediol, and 1,6-hexanediol. In still another embodiment, the chain extender in the embodiment 1 is ethylene glycol, and/or 1,3-propanediol.

In the context of the present invention, the amount of the chain extender and the polyol composition may vary within wide ranges. In one embodiment, the weight ratio between the chain extender and the polyol composition in the embodiment 1 is in between 0.01:1.0 to 0.1:1.0. In another embodiment, the weight ratio between the chain extender and the polyol composition in the embodiment 1 is in between 0.01:1.0 to 0.09:1.0, or in between 0.02:1.0 to 0.09:1.0, or in between 0.02:1.0 to 0.08:1.0. In still another embodiment, the weight ratio between the chain extender and the polyol composition in the embodiment 1 is in between 0.02:1.0 to 0.07:1.0, or in between 0.03:1.0 to 0.07:1.0, or in between 0.04:1.0 to 0.07:1.0.

For the preparation of the cross-linked TPU of the embodiment 1, a suitable isocyanate index is required to be maintained. The index is defined here as the ratio of the total for number of isocyanate groups of the isocyanate composition used in the reaction to the isocyanate- reactive groups, i.e., the groups of polyol composition and the chain extender. At an index of 100, there is one active hydrogen atom per isocyanate group of the isocyanate composition. At indices exceeding 100, there are more isocyanate groups than isocyanate-reactive groups. In an embodiment, the index for preparing the cross-linked TPU of the embodiment 1 is in between 90 to 110.

In an embodiment, the mixture in the embodiment 1 further comprises catalysts (d) and additives (e). These substances are known per se to those skilled in the art. According to the invention, it is also possible to use combinations of two or more catalysts and/or additives.

In an embodiment, the additives in the mixture in the embodiment 1 can be selected from surface-active substances, flame retardants, nucleating agents, oxidation stabilizers, lubricants and mold release agents, dyes and pigments, stabilizers against hydrolysis, light, heat or discoloration, inorganic and/or organic fillers, reinforcing materials, and plasticizers. Suitable additives can be found, for example, in the Kunststoffhandbuch, volume VII, edited by Vieweg and Hochtlen, Carl Hanser Verlag, Munich 1966 (p. 103-113).

Suitable catalysts are likewise known in principle from the prior art. Suitable catalysts are, for example, organic metal compounds selected from the group consisting of tin organyls, titanium organyls, zirconium organyls, hafnium organyls, bismuth organyls, zinc organyls, aluminum organyls and iron organyls, for example tin organyl compounds, preferably tin dialkyls such as dimethyltin or diethyltin, or tin organyl compounds of aliphatic carboxylic acids, preferably tin diacetate, tin dilaurate, dibutyltin diacetate, dibutyltin dilaurate, bismuth compounds such as bismuth alkyl compounds or the like, or iron compounds, preferably iron(MI) acetylacetonate, or the metal salts of the carboxylic acids, for example tin(II) isooctoate, tin dioctoate, titanic esters or bismuth(III) neodecanoate.

In another embodiment, the catalysts are selected from tin compounds and bismuth compounds, further preferably tin alkyl compounds or bismuth alkyl compounds. The catalysts are typically used in the mixture in the embodiment 1 in amounts less than 2000 ppm, or in between 1 ppm to 1000 ppm, or in between 2 ppm to 500 ppm.

The properties of the cross-linked TPU of the embodiment 1 may vary within wide ranges according to the application. In one embodiment, the cross-linked TPU of the embodiment 1 has a Shore hardness of the cross-linked TPU of the embodiment 1 in ranging between 35 A to 85 D, determined according to ASTM D2240-15e1. In another embodiment, the Shore hardness of the cross-linked TPU of the embodiment 1 is in between 35 A to 85 A, or in between 40 A to 85 A, or in between 60 A to 85 A.

Physical properties, for example extended elastic performance, in combination with acceptable mechanical properties, such as but not limited to, abrasion resistance, tensile strength of the cross-linked TPU are surprisingly achieved by using an isocyanate having functionality (f)>2.0, i.e. the first isocyanate in the embodiment 1. For example, for a TPU with the Shore hardness of about 70 A, the incorporation of first isocyanate allowed to achieve an extension in the elastic plateau in between 10° C. to 40° C., depending on the mass fraction of the first isocyanate and the hardness level of the targeted TPU. Also, the tensile strength and the wear resistance of the resultant cross-linked TPUs increased by about 5-70% compared to the control TPUs, i.e. with isocyanates having f≤2.0. In one embodiment, tensile strength and strain at break can be determined in accordance with ASTM D412 and abrasion resistance can be determined in accordance with DIN 53504.

Moreover, the inventive process of the embodiment 1 can be carried out on conventional systems with improved cycle time, thereby rendering it useful for producing injection molded products, extrusion products, films and shaped bodies, in particular outsoles for footwear.

Hereinafter, the cross-linked TPUs of the embodiment 1 having extended elastic plateau may alternatively also referred to as high heat TPU (HHTPU). The upper limit of the extended elastic plateau of the HHTPU is defined by temperature at which the elastic modulus begins dropping precipitously. This drop is defined by the rise in the viscous dissipation determined hereon by the rise in the magnitude of tan δ, defined as:

$$tan δ = \frac{{G}^{″}}{{G}^{′}}$$

where G′ and G″ are the elastic and viscous moduli, respectively.

Therefore, the upper limit of the extent in the elastic plateau is determined by the temperature at which tan δ increases its magnitude by about threefold with respect to the magnitude of the tan δ in the elastic plateau (i.e., the tan δ value in the temperature range between about 40° C. and 90° C.). The HHTPU has the Shore hardness value that meets the required criteria, while having the elastic plateau increased by at least 10° C., compared to a conventional TPU. Additionally, the HHTPU material has modulus, strength and elongation at break. In particular, at least one of the properties of HHTPU material of the embodiment 1 is superior to a property of any conventional TPU.

In one embodiment, the elastic plateau or elastic range of the HHTPU of embodiment 1 is determined by the temperature range where the tan δ value is less than 0.2. A dynamic mechanical analysis (DMA) of the TPU samples at a heating rate of 5° C./min in accordance with ASTM E1640 can be used for determining the tan δ values and accordingly the elastic plateau. Suitable equipments for this purpose include TA Instruments RSA3 DMA, available in the market.

The reaction of the mixture in the embodiment 1 can in principle be conducted under reaction conditions known per se. For instance, the reaction of the mixture can be affected batchwise or else continuously, for example in a belt process or a reactive extrusion process. Suitable processes are described, for example, in EP 0 922 552 A1 or WO 2006/082183 A1.

In an embodiment, the reaction of the mixture in the embodiment 1 can be conducted at elevated temperatures relative to room temperature. For example, the mixture in the embodiment 1 is reacted at temperature ranging between 50° C. to 230° C. Further, the heating can be affected in any suitable manner known to those skilled in the art.

In another embodiment, the mixture comprising (a), (b), (c), and optionally (d) and/or (e) in the embodiment 1 is homogenously mixed and processed by means of extrusion or injection molding. For example, reaction extrusion, as may be commonly known to those skilled in the art, may be suitable for processing the mixture of the embodiment 1, whereby ingredients (a), (b), (c), and optionally (d) and/or (e) would be dosed in their respective ratios and reacted in situ during the extrusion, resulting in the cross-linked TPU synthesis. For reactive extrusion, the zone temperature is in between 170° C. to 245° C. According to the invention, it is also possible that the process comprises further steps, for example a pre-treatment of the ingredients or an aftertreatment of the cross-linked TPU obtained in the embodiment 1. Accordingly, the present invention also relates, in a further embodiment, to a process for preparing the cross-linked TPU as described above, wherein the cross-linked TPU obtained is heat-treated after the conversion.

Another aspect of the present invention is embodiment 2, directed towards the cross-linked TPU, as described in embodiment 1. With regards to the embodiments of the cross-linked TPU, suitable ingredients and their respective amounts and/or ratios, reference is made to the above embodiment 1 which applies correspondingly.

Still another aspect of the present invention is embodiment 3, directed towards the use of the cross-linked TPU of embodiment 1 or 2 for production of injection molded products, extrusion products, films and shaped bodies. In an embodiment, the shaped body of the embodiment 3 is an outsole for an article of footwear.

Injection molded products of the cross-linked TPU of the embodiment 1 or 2 are obtained at temperature ranging between 100° C. to 250° C. Circumferential velocity during plasticization is preferably less than or equal to 0.2 m/s, and the back pressure is in between 30 bar to 200 bar. The injection velocity is usually low in order to keep the shear stress low. The cooling time is chosen so as to be sufficiently long, with the hold pressure being from 30% to 80% of the injection pressure. The molds are typically heated in between 30° C. to 70° C. In the case of wide area over injection, an injection point cascade can be used. Additionally, further thermoplastic polymers can also be used in the injection molded products. Suitable examples of these thermoplastic polymers include, such as but not limited to, polyamides, polyesters, polycarbonates, and ABS. Due to the cross-linking initiated by the presence of first isocyanate (f>2.0), the cross-linked TPU adheres particularly well to the thermoplastic polymers.

The cross-linked TPU of the embodiment 1 or 2 can be processed by generally known methods, e.g. by means of injection molding or extrusion, to produce moldings of all types, rollers, shoe soles, cladding in automobiles, hoses, cable plugs, bellows, towing cables, wiper blades, cable sheathings, gaskets, belts or damping elements, films or fibers.

A further aspect of the present invention is embodiment 4, directed towards an outsole for an article of footwear comprising the cross-linked TPU of embodiment 1 or 2.

The advantageous effects of the cross-linked TPU of the embodiment 1 or 2, such as improved thermal and mechanical properties, for example abrasion resistance, extended elastic performance, and glass transition temperature, make the cross-linked TPU well suited for utilization in manufacturing outsoles for articles of footwear, for e.g. a shoe. For instance, in a shoe having an upper that is secured to a midsole, said midsole is secured to the outsole. Suitable materials for securing the different layers of a shoe are well known to the person skilled in the art. Such a shoe design is described in greater details by U.S. Pat. Nos. 7,225,491 and 6,749,781.

Yet another aspect of the present invention is embodiment 5, directed towards an article of footwear comprising an upper, a midsole and the outsole of embodiment 4.

The presently claimed invention is illustrated in more detail by the following embodiments and combinations of embodiments which results from the corresponding dependency references and links:
I. A process for preparing a crosslinked thermoplastic polyurethane, said process comprising at least reacting a mixture comprising:
   (a) an isocyanate composition comprising a first isocyanate which is a carbodiimide- modified isocyanate having an isocyanate functionality ranging between 2.1 to 2.7,
   (b) a polyol composition comprising at least one polyol having a nominal functionality ranging between 1.8 to 2.5 and OH value ranging between 20 mg KOH/g to 500 mg KOH/g, and
   (c) at least one chain extender.
II. The process according to embodiment I, wherein the isocyanate functionality of the first isocyanate is in between 2.1 to 2.5.
III. The process according to embodiment I or II, wherein the isocyanate functionality of the first isocyanate is in between 2.1 to 2.2.
IV. The process according to one or more of embodiments I to III, wherein the first isocyanate has an isocyanate content of less than 50 wt.-%.
V. The process according to one or more of embodiments I to IV, wherein the first isocyanate has an isocyanate content ranging between 1 wt.-% to 35 wt.-%, or in between 25 wt.-% to 35 wt.-%.
VI. The process according to one or more of embodiments I to V, wherein the first isocyanate is selected from a carbodiimide-modified diphenylmethane 2,2′-, 2,4′- and/or 4,4′-diisocyanate.
VII. The process according to one or more of embodiments I to VI, wherein the isocyanate composition further comprises a second isocyanate having an isocyanate functionality of at least 2.0, said second isocyanate being different than the first isocyanate.
VIII. The process according to embodiment VII, wherein the second isocyanate has an isocyanate content of at least 5.0 wt.-%.
IX. The process according to embodiment VII or VIII, wherein the second isocyanate is selected from a prepolymer based on diphenylmethane 2,2′-, 2,4′- and/or 4,4′-diisocyanate, isocyanates comprising biuret and/or isocyanurate groups, diphenylmethane 2,2′-, 2,4′- and/or 4,4′-diisocyanate, and polymeric methylene diphenyl diisocyanate.
X. The process according to one or more of embodiments VI to IX, wherein the weight ratio between the first isocyanate and the second isocyanate is in between 1.0:100.0 to 100.0:1.0.
XI. The process according to one or more of embodiments VI to X, wherein the weight ratio between the first isocyanate and the second isocyanate is in between 1.0:5.0 to 5.0:1.0.
XII. The process according to one or more of embodiments Ito XI, wherein the polyol has a nominal functionality ranging between 1.9 to 2.1 and OH value ranging between 30 mg KOH/g to 100 mg KOH/g.
XIII. The process according to one or more of embodiments Ito XII, wherein the polyol is selected from polyester polyol, polyether polyol, and polycarbonate polyol.
XIV. The process according to one or more of embodiments Ito XIII, wherein the polyol comprises either a polyether or a polyester polyol having a nominal functionality ranging between 1.9 to 2.1 and OH value ranging between 40 mg KOH/g to 70 mg KOH/g.
XV. The process according to one or more of embodiments Ito XIV, wherein the chain extender has a molecular weight of less than 499 g/mol.
XVI. The process according to one or more of embodiments Ito XV, wherein the chain extender has a molecular weight ranging between 50 g/mol to 210 g/mol.
XVII. The process according to one or more of embodiments Ito XVI, wherein the chain extender is selected from ethane-1,2-diol, 1,3-propanediol, 1,4-butanediol, 1,5-pentanediol, 1,6-hexanediol, heptane diol, octanediol, and mixtures thereof.
XVIII. The process according to one or more of embodiments Ito XVII, wherein the chain extender is ethane-1,2-diol and/or 1,3-propanediol.
XIX. The process according to one or more of embodiments I to XVIII, wherein the mixture is reacted at an index ranging between 90 to 110.
XX. The process according to one or more of embodiments I to XIX, wherein the mixture is reacted at a temperature ranging between 50° C. to 230° C.
XXI. The process according to one or more of embodiments I to XX, wherein the mixture further comprises catalysts (d), additives (e), and mixtures thereof.
XXII. The process according to embodiment XXI, wherein the additive (e) is selected from surface-active substances, flame retardants, nucleating agents, oxidation stabilizers, lubricants and mold release agents, dyes and pigments, stabilizers against hydrolysis, light, heat or discoloration, inorganic and/or organic fillers, reinforcing materials, and plasticizers.
XXIII. The process according to one or more of embodiments I to XXII, wherein the mixture comprising (a), (b), (c), and optionally (d) and/or (e) is homogeneously mixed and processed by means of extrusion or injection molding.
XXIV. The process according to one or more of embodiments I to XXIII, wherein the crosslinked thermoplastic polyurethane has a Shore hardness ranging between 35 A to 85 D, or in between 60 A to 85 A.
XXV. A crosslinked thermoplastic polyurethane obtained according to one or more of embodiments I to XXIV.
XXVI. Use of the crosslinked thermoplastic polyurethane according to embodiment XXV or as obtained according to one or more of embodiments I to XXIV for production of injection molded products, extrusion products, films and shaped bodies.
XXVII. The use according to embodiment XXVI, wherein the shaped body is an outsole for an article of footwear.
XVIII. An outsole for an article of footwear comprising the crosslinked thermoplastic polyurethane according to embodiment XXV or as obtained according to one or more of embodiments I to XXIV.
XXIX. An article of footwear comprising an upper, a midsole and an outsole according to embodiment XXVIII.

### EXAMPLES

The presently claimed invention is illustrated by the non-restrictive examples which are as follows:

Raw materials
ISOCYANATE REACTIVE COMPONENT (IRC)

| | |
|---|---|
| P1 | Adipic acid based polyester polyol having a nominal functionality |
| | ranging between 1.9 to 2.1 and OH value in between |
| | 50 mg KOH/g to 60 mg KOH/g, obtained from BASF. |

ISOCYANATE (ISO)

| | |
|---|---|
| ISO 1 | Pure 4,4′-MDI having a nominal functionality of 2.0 and an |
| | isocyanate content of 33.5 wt. %, obtained from BASF. |
| ISO 2 | Carbodiimide modified 4,4′-MDI having a nominal functionality |
| | of 2.1 and an isocyanate content in between 28 wt. % to 30 wt. %, |
| | obtained from BASF. |

ADDITIVES (AD)

| | |
|---|---|
| AD 1 | Elastostab ® H01 - Hydrolysis stabilizer from BASF |
| AD 2 | Irganox ® B - Thermal stabilizer from BASF |
| AD 3 | Licowax ® E - Lubricant and dispersing agent from Clariant |

Standard method

| | |
|---|---|
| DIN 53240-1 | OH value |
| ASTM D2240-15e1 | Shore hardness |
| ASTM D412 | Tensile strength, and strain at break |
| DIN 53504 | Abrasion resistance |
| ASTM E1640 | Dynamic mechanical analysis |

### General Synthesis of TPU by Casting

Mixtures were prepared using the aforementioned raw materials, with stirring in a reaction vessel. The start temperature was 80° C. On attainment of a reaction temperature of 110° C., the mixture was poured onto a hotplate heated to 125° C., and the TPU sheet obtained was pelletized after the heat treatment (15 h, 80° C.).

The synthesis and properties of the cross-linked TPUs obtained are compiled in Tables 1-3. The chain extenders used in all the comparative and inventive examples had a molecular weight in between 50 g/mol to 210 g/mol and include single components as well as mixtures thereof.

TABLE 1
Inventive and comparative TPUs prepared by casting

| Ingredient | Comp. Ex. 1 | Inv. Ex. 1 | Inv. Ex. 2 |
|---|---|---|---|
| IRC* | 77.2 | 76.9 | 75.7 |
| ISO 1 | 22.8 | 18.0 | 0.0 |
| ISO 2 | 0.0 | 5.1 | 24.3 |
| Index | 100 | 100 | 100 |
| Hard phase content (%) | 17.0 | 17.0 | 17.0 |

Properties at T = 25° C.

| | | | |
|---|---|---|---|
| Tensile Strength, MPa | 17.3 | 24.0 | 25.2 |
| Tensile Strain at Break, | 641 | 524 | 459 |
| % | | | |
| Abrasion, mm³ | 54.6 | 16.7 | 15.7 |

*P1 + chain extenders

TABLE 2
DMA data for inventive and comparative TPUs from Table 1

| TPU | Elastic Range (when tan δ < 0.2), ΔT, ° C. |
|---|---|
| Comp. Ex. 1 | −2.6 to 124 |
| Inv. Ex. 1 | −2.5 to 144 |
| Inv. Ex. 2 | 3.9 to 167 |

The elastic range is determined by the temperature range where the tan δ value is less than 0.2. The samples were analysed according to ASTM E1640 using the dynamic temperature ramp method at a heating rate of 5° C./min on TA Instruments RSA3 DMA.

### General Synthesis of TPUs Using Reactive Extrusion Method

The second housing of a ZSK 32 twin-shaft extruder from Werner & Pfleiderer, Stuttgart, having a process length of 56 D, was charged with the chain extender (dosed separately in Zone 5) and polyol at a charge temperature of 160° C. and, separately therefrom, the isocyanate was metered into the second housing at a charge temperature of 65° C., along with the additives (added in first zone). The speed of the twin screw was 260 rpm. The set temperature values for the housing were, in flow direction, (see protocol) 200° C. in the first third of the screw, 170° C. in the second third of the screw, and 190° C. in the last third of the screw. The expulsion rate was 20 kg/h. After the melt chopping by underwater pelletization and integrated centrifugal drying, the pellets were subjected to final drying at about 80° C. to 90° C.

The injection molding was done on a 30 mm hydraulic driven IM machine with 3 Zones and the screw with 70 rpm. The temperature profile in Zones 1, 2 3, and the die were: 200° C., 210° C., 210° C., and 215° C., respectively. The back pressure was 32 bars and the injection pressure was 35 bars. Form temperature was 25° C. The test plaques produced had thickness of 2 mm and 6 mm, which were subsequently annealed for 20 h at a temperature of 100° C., prior to physical testing.

TABLE 3
Inventive and comparative TPUs prepared via reactive extrusion

| Ingredient | Comp. Ex. 2 | Inv. Ex. 3 | Inv. Ex. 4 |
|---|---|---|---|
| IRC* | 75.1 | 70.8 | 74.3 |
| ISO 1 | 23.6 | 14.2 | 14.1 |
| ISO 2 | 0 | 8.6 | 8.54 |
| AD^{#} | 1.3 | 3.3 | 3.3 |
| Index | 103 | 101.5 | 101.5 |
| Hard phase content (%) | 17.0 | 17.0 | 17.0 |

Properties at T = 25° C.

| | | | |
|---|---|---|---|
| Tensile Strength, MPa | 21.45 | 26.3 | 30.1 |
| Tensile Strain at Break, | 755 | 676 | 645 |
| % | | | |
| Abrasion loss on smooth | 100 | 47 | n.d. |
| surface, % | | | |

Properties at T = 80° C.

| | | | |
|---|---|---|---|
| Tensile Strength, MPa | 4.45 | 7.23 | 9.01 |
| Tensile Strain at Break, | 497 | 894 | 1081 |
| % | | | |

*P1 + chain extenders
^{#}AD1 + AD2 + AD3

Abrasion loss on smooth surface was calculated with Comp. Ex. 1 as the basis. For this, samples were prepared in accordance with DIN 53504 with sliding linear velocity of 0.4 m/s, normal stress of 157 kPa and for a test time of 10 s.

The cross-linking in the TPUs of Inv. Ex. 1-4 is evident from the tensile strength values at different temperatures, abrasion resistance and the extent of the elastic plateau (refer elastic range in Table 2). These technical effects were not evident in the conventional TPUs, i.e. Comp. Ex. 1 and 2, which were based on pure 4,4′-MDI only.

1: A process for preparing a crosslinked thermoplastic polyurethane, said process comprising:
reacting a mixture comprising:
(a) an isocyanate composition comprising a first isocyanate which is a carbodiimide-modified isocyanate having an isocyanate functionality ranging between 2.1 to 2.7,
(b) a polyol composition comprising at least one polyol having a nominal functionality ranging between 1.8 to 2.5 and an OH value ranging between 20 mg KOH/g to 500 mg KOH/g, and
(c) at least one chain extender.

2: The process according to claim 1, wherein the isocyanate functionality of the first isocyanate is in between 2.1 to 2.2.

3: The process according to claim 1, wherein the first isocyanate has an isocyanate content ranging between 1 wt.-% to 35 wt.-%.

4: The process according to claim 1, wherein the first isocyanate is selected from a carbodiimide-modified diphenylmethane 2,4′- and/or 4,4′-diisocyanate.

5: The process according to claim 1, wherein the isocyanate composition further comprises a second isocyanate having an isocyanate functionality of at least 2.0, said second isocyanate being different than the first isocyanate.

6: The process according to claim 5. wherein the second isocyanate is a prepolymer based on diphenylmethane 2,2′-, 2,4′- and/or 4,4′-diisocyanate, an isocyanate comprising biuret and/or isocyanurate groups, diphenylmethane 2,2′-, 2,4′- and/or 4,4′-diisocyanate, and/or polymeric methylene diphenyl diisocyanate.

7: The process according to claim 5, wherein a weight ratio between the first isocyanate and the second isocyanate is in between 1.0:5.0 to 5.0:1.0.

8: The process according to claim 1, wherein the at least one polyol comprises either a polyether or a polyester polyol having a nominal functionality ranging between 1.9 to 2.1 and an OH value ranging between 40 mg KOH/g to 70 mg KOH/g.

9: The process according to claim 1, wherein the at least one chain extender has a molecular weight ranging between 50 g/mol to 210 g/mol.

10: The process according to claim 1, wherein the crosslinked thermoplastic polyurethane has a Shore hardness ranging between 60 A to 85 A.

11: A crosslinked thermoplastic polyurethane, obtained according to the process according to claim 1.

12: An article, comprising the crosslinked thermoplastic polyurethane according to claim 11, wherein the article is selected from the group consisting of an injection molded product, extrusion product, film, and shaped body.

13: An outsole for an article of footwear, comprising:
the crosslinked thermoplastic polyurethane according to claim 11.

14: An article of footwear, comprising:
an upper,
a midsole, and
an outsole according to claim 13.
